(19) United States
(12) Patent Application Publication
(10) Pub. No.: US 2013/0147151 A1
(43) Pub. Date: Jun. 13, 2013

(54) PNEUMATICALLY SUPPORTED BICYCLE SEAT ASSEMBLY

(71) Applicant: Edward J. Noble, Coronado, CA (US)

(72) Inventor: Edward J. Noble, Coronado, CA (US)

(73) Assignee: Noble Ideas Inc.

(21) Appl. No.: 13/315,136

(22) Filed: Dec. 8, 2011

(51) Int. Cl. B62J 1/26; B62M 1/02

(52) U.S. Cl. 280/259; 297/199

(57) ABSTRACT

An improved bicycle seat assembly with pneumatic support, which is adapted for use with a standard bicycle seat post. The pneumatic support of the seat assembly comprises an inflatable bladder positioned between and retained by upper and lower retaining plates. The inflatable bladder is preferably the shape of an annular ring like a bicycle tire inner tube and includes a valve stem to adjust the level of inflation of the inflatable bladder.

### FIELD

The embodiments described herein relate generally to bicycle seats and, more particularly, to a bicycle seat assembly with pneumatic support.

### BACKGROUND INFORMATION

Over the past several years, bicycling has regained popularity. As people take to their bikes, more than ever and for a multitude of reasons, one serious problem with bikes has not been addressed—the uncomfortable and numbing bicycle saddle or seat. Pain and discomfort of the perineum, the buttocks, the genitals and the inner thighs has become an accepted fact of life for bicyclists. Despite a vast array of improvements in bicycling apparatus, a comfortable bicycle seat remains absent. Many attempts at improving the comfort of a bicycle seat have focused on the seat cushion. But, current designs and apparatus are found to still be deficient.

Thus, it is desirable to provide a bicycle seat assembly that facilitate riding comfort for the bicyclist.

### SUMMARY

The present system is directed to an improved bicycle seat assembly with pneumatic support, which is adapted for use with a standard bicycle seat post. The pneumatic support of the seat assembly comprises an inflatable bladder positioned between and retained by upper and lower retaining plates. The inflatable bladder is preferably the shape of an annular ring like a bicycle tire inner tube and includes a valve stem to adjust the level of inflation of the inflatable bladder. In addition to an annular ring, the bladder can be of any shape including, but not limited to, a triangle, square, rectangle, octagon, and the like, but preferably with an internal periphery about a central hole to allow coupling hardware for the upper and lower retaining plates to pass.

The systems, methods, features and advantages of the invention will be or will become apparent to one with skill in the art upon examination of the following figures and detailed description. It is intended that all such additional methods, features and advantages be included within this description, be within the scope of the invention, and be protected by the accompanying claims. It is also intended that the invention is not limited to require the details of the example embodiments.

### BRIEF DESCRIPTION

The accompanying drawings, which are included as part of the present specification, illustrate the presently preferred embodiment and, together with the general description given above and the detailed description of the preferred embodiment given below, serve to explain and teach the principles of the present invention.

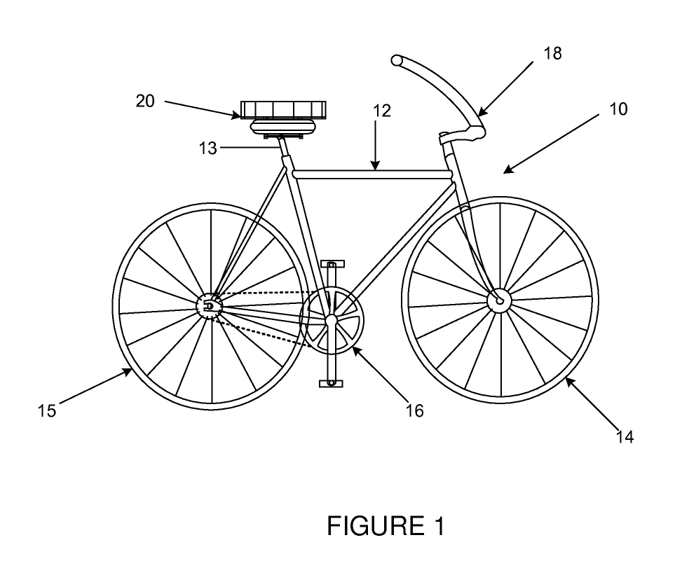

FIG. 1 illustrates an plan view of a bicycle with a seat assembly in accordance with the present system.

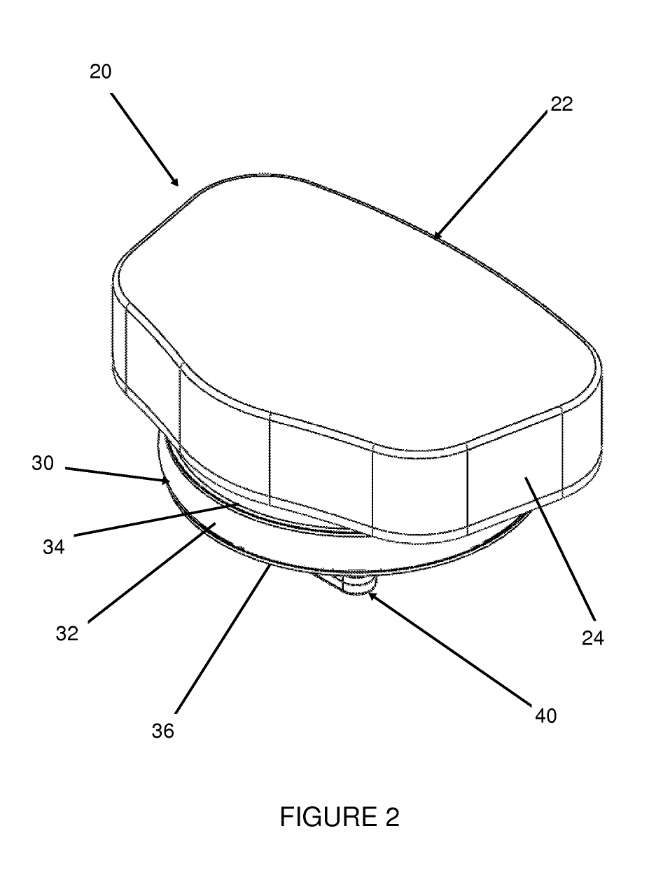

FIG. 2 illustrates an isometric assembled view of an embodiment of the present bicycle seat assembly viewed from a top of the seat perspective.

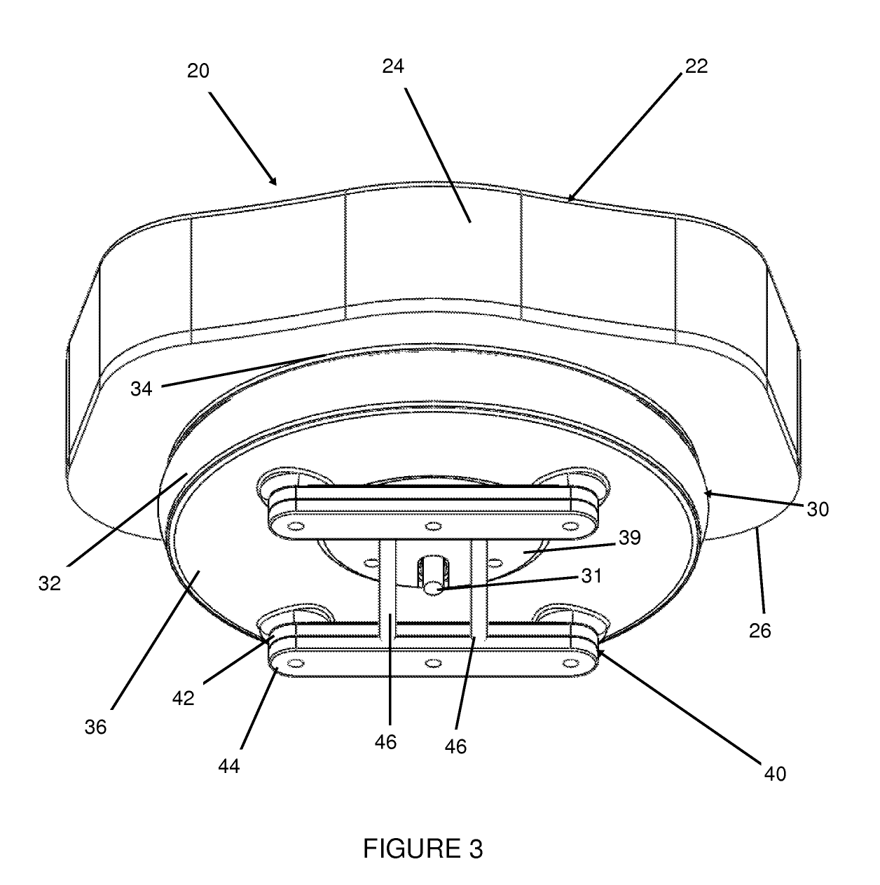

FIG. 3 illustrates an isometric assembled view of the present bicycle seat assembly shown in FIG. 2 viewed from a bottom of the seat perspective.

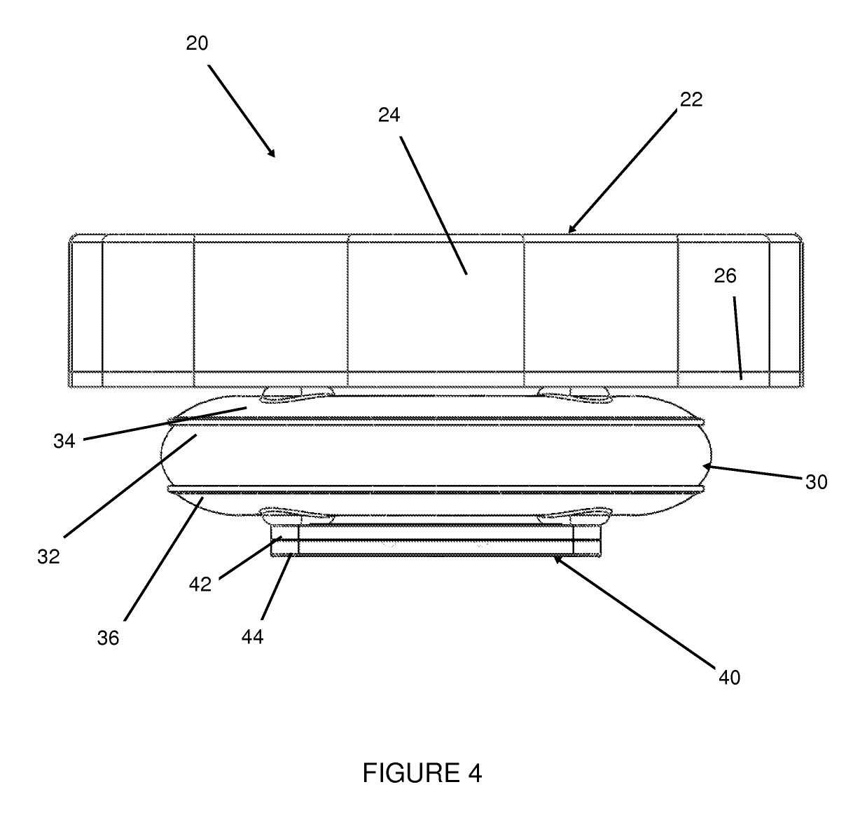

FIG. 4 illustrates a front elevation assembled view of the present bicycle seat assembly shown in FIG. 2.

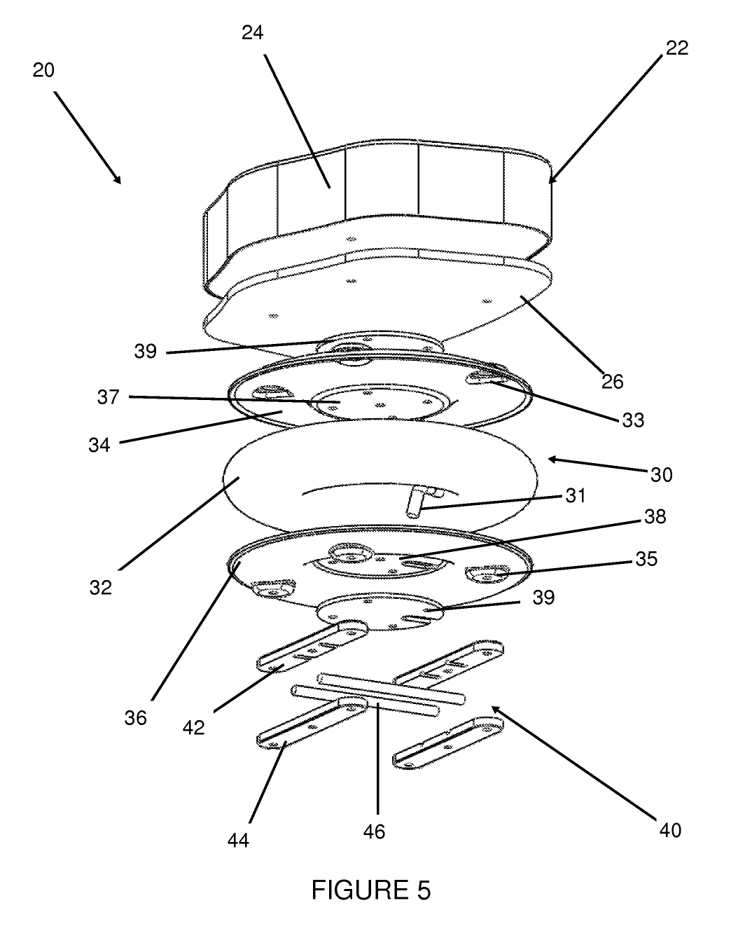

FIG. 5 illustrates an isometric exploded assembly view of the present bicycle seat assembly shown in FIG. 2 viewed from a bottom of the seat perspective.

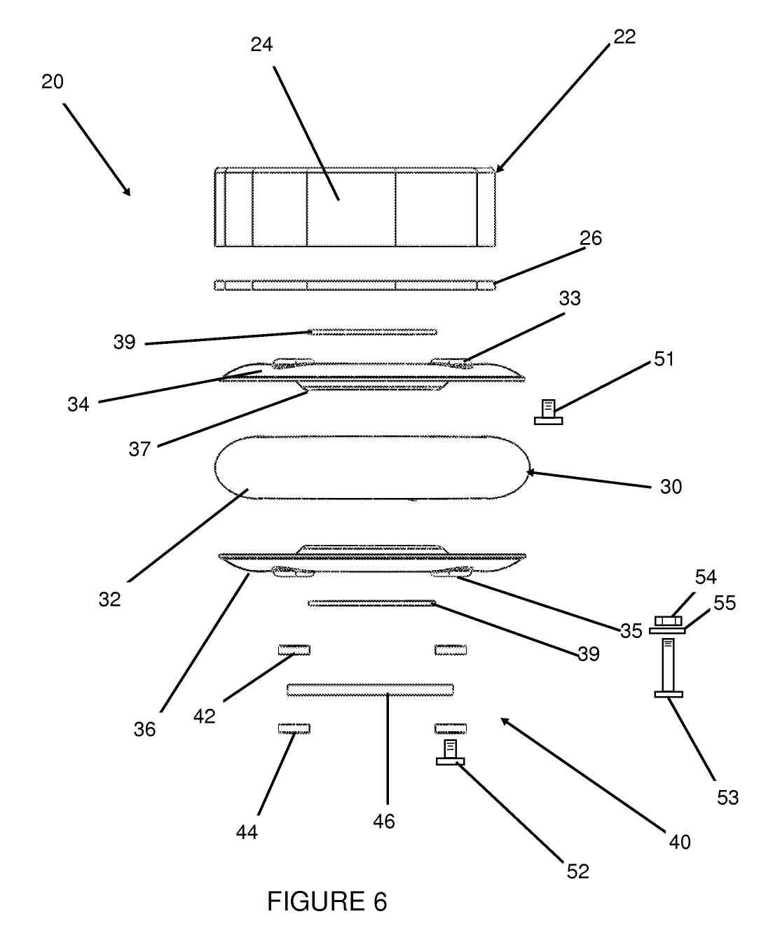

FIG. 6 illustrates a front elevation exploded assembly view of the present bicycle seat assembly shown in FIG. 2.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not necessarily describe every aspect of the teachings disclosed herein and do not limit the scope of the claims.

### DETAILED DESCRIPTION

The present system is directed to an improved bicycle seat assembly with pneumatic support and adapted for use with a standard bicycle seat post with the specific embodiment shown in the attached drawings. A bicycle 10 having a frame 12 is shown in FIG. 1. The bicycle 10 includes front and rear wheels 14 and 15 coupled to the frame and having tires mounted thereon. A drive train 16 is coupled to the frame 12 and includes a chain crank, pedals coupled to opposing pedal arms attached to the chain crank, and a chain coupled to the chain crank and extending to a rear wheel sprocket. A seat assembly 20 is shown coupled to a seat stay 13 extending from the bicycle frame 12.

Referring to FIGS. 2-6, the bicycle seat assembly 20 includes a generally rectangular bench-like seat 22 that is hornless or nose-less and comprising a thick seat cushion 24 having an exterior covering which is in contact with the seated bicyclist, which is preferably a soft, flexible leather, lycra, or other suitable durable material. The exterior covering is sewn together to fit over the cushion and be fixed or coupled to a seat frame 26. The seat frame 26 is formed from a rigid material such as steel, plastic and the like.

As depicted, the seat 22 is coupled to a pneumatic support 30. The pneumatic support 30 comprises an inflatable bladder 32 positioned between and retained by an upper retaining plate 34 and a lower retaining plate 36. In an alternative embodiment, the upper retaining plate 34, which is depicted as a standalone component, can be combined with the seat frame 26 as a single component.

The inflatable bladder 32 is preferably in the shape of an annular ring like a bicycle tire inner tube and includes a valve stem 31 to adjust the level of inflation of the inflatable bladder 32. The bladder 32 can be of any shape including, but not limited to, a triangle, square, rectangle, octagon, and the like, but preferably with an internal periphery about a central hole to allow coupling hardware for the upper and lower retaining plates 34 and 36 to pass. If the bladder 32 does not include a central hole, air tight through holes would need to be formed through the bladder 32 to accommodate coupling hardware for the upper and lower retaining plates 34 and 36.

The upper and lower retaining plates 34 and 36 include two or more mounting holes 33 and 35 to couple the upper retaining plate 34 to the seat frame 26 and the lower retaining plate 34 to a seat stem mounting bracket 40 using mounting screws or bolts 51 and 52. The upper and lower retaining plates 34 and 36 are similarly shaped with raised central regions 37 and 38 with an annular recess formed about the periphery of the raised central regions 37 and 38 of the retaining plates 34 and 36. Coupling plates 39 are positionable over the central regions 37 and 38 of the retaining plates 34 and 36. Two or more bolts 53 with corresponding nuts 54 and washers 55 extend between coupling plates 39 to fix the distant to which the upper and lower retaining plates 34 and 36 can separate from one another.

The bracket 40 includes upper and lower cross members 42 and 44, which when coupled together by the mounting screws 52 coupling the cross members 42 and 44 to the lower retaining plate 36, the cross members 42 and 44 retain a pair of seat stem mounting rails 46 there between.

In operation, an assembled bicycle seat assembly 20 is mounted on a seat stem 13 (FIG. 1) using the seat stem mounting rails 46. The inflatable bladder 32 is then filled with or drained of air through the valve stem 31 to adjust the inflation level of the inflatable bladder 32 to the desired comfort level of the bicyclist.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the spirit and scope of the appended claims.

In the description above, for purposes of explanation only, specific nomenclature is set forth to provide a thorough understanding of the present disclosure. However, it will be apparent to one skilled in the art that these specific details are not required to practice the teachings of the present disclosure.

The various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter.

A bicycle seat assembly with pneumatic support has been disclosed. It is understood that the embodiments described herein are for the purpose of elucidation and should not be considered limiting the subject matter of the disclosure. Various modifications, uses, substitutions, combinations, improvements, methods of productions without departing from the scope or spirit of the present invention would be evident to a person skilled in the art.

What is claimed is:

1. A bicycle seat assembly, comprising:
a seat frame,
a seat cushion coupled to the seat frame, and
a pneumatic support system coupled to the seat frame.

2. The bicycle seat assembly of claim 1, wherein the pneumatic support system includes an inflatable bladder positioned between the seat frame and a first retaining plate, wherein the first retaining plate is operably coupled to the seat frame.

3. The bicycle seat assembly of claim 2, further comprising a seat cover positioned over the cushion and coupled to the seat frame.

4. The bicycle seat assembly of claim 2, wherein the seat cushion and the seat frame form a hornless assembly.

5. The bicycle seat assembly of claim 2, wherein the inflatable bladder comprises an outer periphery and an inner periphery, wherein the inner periphery extends about a hole formed through the inflatable bladder.

6. The bicycle seat assembly of claim 5, wherein the inflatable bladder is formed in a tubular annular ring shape.

7. The bicycle seat assembly of claim 2, further comprising a seat post mounting bracket coupled to the first retaining plate.

8. The bicycle seat assembly of claim 2, further comprising a second retaining plate coupled to the seat frame and operably coupled to the first retaining plate, wherein the inflatable bladder is position between and retained by the first and second retaining plates.

9. A bicycle comprising
a frame, and
a bicycle seat assembly with pneumatic support system coupled to the frame.

10. The bicycle of claim 9 further comprising
front and rear wheels coupled to the frame and having tires mounted thereon,
a drive train coupled to the frame and including a chain crank, pedals coupled to opposing pedal arms attached to the chain crank, and a chain coupled to the chain crank and extending to a rear wheel sprocket, and
a set of handle bars coupled to the frame.

11. The bicycle of claim 9 further comprising a seat stay extending from the bicycle frame and a seat post extending from the seat post.

12. The bicycle of claim 11, wherein the pneumatic support system includes an inflatable bladder positioned between a seat frame and a first retaining plate, wherein the first retaining plate is operably coupled to the seat frame.

13. The bicycle of claim 12, wherein the bicycle seat assembly includes a cushion and a seat cover positioned over the cushion and coupled to the seat frame.

14. The bicycle of claim 12, wherein the seat cushion and the seat frame form a hornless assembly.

15. The bicycle of claim 12, wherein the inflatable bladder comprises an outer periphery and an inner periphery, wherein the inner periphery extends about a hole formed through the inflatable bladder.

16. The bicycle of claim 15, wherein the inflatable bladder is formed in a tubular annular ring shape.

17. The bicycle of claim 12, further comprising a seat post mounting bracket coupled to the first retaining plate.

18. The bicycle of claim 12, further comprising a second retaining plate coupled to the seat frame and operably coupled to the first retaining plate and the seat post, wherein the inflatable bladder is positioned between and retained by the first and second retaining plates.
